(19) United States
(12) Patent Application Publication
(10) Pub. No.: US 2026/0162614 A1
(43) Pub. Date: Jun. 11, 2026

(54) PIXEL CIRCUIT, DISPLAY APPARATUS AND DRIVING METHOD

(71) Applicants: Chengdu BOE Optoelectronics Technology Co., Ltd., Chengdu, Sichuan (CN); BOE Technology Group Co., Ltd., Beijing (CN)

(72) Inventor: Yonglin GUO, Beijing (CN)

(21) Appl. No.: 18/705,573

(22) PCT Filed: Nov. 30, 2022
(86) PCT No.: PCT/CN2022/135415

§ 371 Date: Apr. 28, 2024

(51) Int. Cl. G09G 3/3241

(52) U.S. Cl. CPC G09G 3/3241; G09G 2300/0819; G09G 2300/0842; G09G 2320/045

(57) ABSTRACT

Embodiments of the present disclosure provide a pixel circuit, a display apparatus, and a driving method, wherein the pixel circuit comprises: a light-emitting device; a drive transistor coupled to the light-emitting device and configured to generate an operating current to drive the light-emitting device based on a data voltage; a first control circuit coupled to a gate of the drive transistor and configured to reduce a leakage current of the gate of the drive transistor based on a signal from a leakage adjustment signal terminal; a second control circuit coupled to the drive transistor and the light-emitting device, respectively, and configured to reset the drive transistor and the light-emitting device, and control the drive transistor to generate the operating current to drive the light-emitting device to emit light.

### CROSS REFERENCE TO RELATED APPLICATIONS

The present disclosure is a national phase entry under 35 U.S.C § 371 of International Application No. PCT/CN2022/135415, filed Nov. 30, 2022, the entire content of which is incorporated herein by reference.

### TECHNICAL FIELD

The present disclosure relates to the field of display technologies, in particular to a pixel circuit, display apparatus and driving method.

### BACKGROUND

Electroluminescent diodes, such as organic light-emitting diodes (OLEDs), quantum dot light-emitting diodes (QLEDs), micro light-emitting diodes (Micro LED), etc., have the advantages of self-luminescence and low energy consumption, which are one of the hotspots in the application research field of electroluminescent display apparatus. Generally, in the electroluminescent display apparatus, the electroluminescent diodes are driven by pixel circuits.

### SUMMARY

Embodiments of the present disclosure provide pixel circuits including:
a light-emitting device;
a drive transistor, coupled to the light-emitting device and configured to, based on a data voltage, generate an operating current to drive the light-emitting device;
a first control circuit, coupled to a gate of the drive transistor and configured to, based on a signal from a leakage adjustment signal terminal, reduce a leakage current of the gate of the drive transistor;
a second control circuit, coupled to the drive transistor and the light-emitting device respectively, and configured to reset the drive transistor and the light-emitting device, control the data voltage to be input into the gate of the drive transistor, and control the drive transistor to generate the operating current to drive the light-emitting device to emit light.

In some possible implementations, the second control circuit includes: a first control sub-circuit; where the first control sub-circuit is configured to provide a signal from a first initialization signal terminal to the light-emitting device in response to a signal from a first control signal terminal, bring a first power supply terminal into conduction with a first electrode of the drive transistor in response to a signal from a first light-emitting control signal terminal, bring a second electrode of the drive transistor into conduction with the light-emitting device in response to a signal from a second light-emitting control signal terminal, bring the gate of the drive transistor into conduction with the second electrode of the drive transistor in response to a signal from a third control signal terminal, and provide a signal from a second initialization signal terminal to the gate of the drive transistor in response to a signal from a fourth control signal terminal.

In some possible implementations, the second control circuit further includes: a second control sub-circuit, configured to provide a data voltage at a data signal terminal to a first node in response to a signal from a second control signal terminal, and provide a signal from a second reference voltage signal terminal to the first node in response to the signal from the third control signal terminal.

In some possible implementations, the second control circuit further includes: a third control sub-circuit; where the third control sub-circuit is configured to provide a signal from a first reference voltage signal terminal to the first electrode of the drive transistor in response to the signal from the first control signal terminal.

In some possible implementations, in one display frame, an effective level of the first control signal terminal occurs before an effective level of the second control signal terminal, and the effective level of the first control signal terminal has an overlapping region with an effective level of the third control signal terminal.

In some possible implementations, the first control signal terminal and the third control signal terminal receive the same one signal; and in one display frame, an effective level of the first control signal terminal occurs before an effective level of the second control signal terminal.

In some possible implementations, in one display frame, an effective level of the first light-emitting control signal terminal has an overlapping region with an effective level of the third control signal terminal, an effective level of the second control signal terminal occurs after the effective level of the third control signal terminal, and an effective level of the first control signal terminal occurs after the effective level of the second control signal terminal.

In some possible implementations, the first control circuit includes: a first transistor and a second transistor; wherein
a gate of the first transistor is coupled to the leakage adjustment signal terminal, a first electrode of the first transistor floats, and a second electrode of the first transistor is coupled to the gate of the drive transistor; and
a gate of the second transistor is coupled to the leakage adjustment signal terminal, a first electrode of the second transistor floats, and a second electrode of the second transistor is coupled to the gate of the drive transistor.

In some possible implementations, the first control circuit includes: a voltage stabilizing capacitor; where a first electrode of the voltage stabilizing capacitor is coupled to the gate of the drive transistor, and a second electrode of the voltage stabilizing capacitor is coupled to the leakage adjustment signal terminal.

In some possible implementations, the first control circuit includes: a compensation transistor;
a first electrode and a second electrode of the compensation transistor are coupled to the leakage adjustment signal terminal, and a gate of the compensation transistor is coupled to the gate of the drive transistor;
or, a gate of the compensation transistor is coupled to the leakage adjustment signal terminal, and a first electrode and a second electrode of the compensation transistor are coupled to the gate of the drive transistor.

In some possible implementations, in one display frame, a voltage of the signal from the leakage adjustment signal terminal is a first voltage when resetting the gate of the drive transistor, and a voltage of the signal from the leakage adjustment signal terminal is a second voltage when inputting the data voltage into the gate of the drive transistor; and
the second voltage is not less than the first voltage.

In some possible implementations, first voltages in different display frames are the same; and
in each of different display frames, the second voltage is greater than a third voltage; and the third voltage is (Vda−Vth), in which Vda represents the data voltage and Vth represents a threshold voltage of the drive transistor.

In some possible implementations, second voltages in different display frames are the same;
or, second voltages in different display frames increase with an increase of third voltages in different display frames.

In some possible implementations, the third control sub-circuit includes: a third transistor; wherein
a gate of the third transistor is coupled to the first control signal terminal, a first electrode of the third transistor is coupled to the first electrode of the drive transistor, and a second electrode of the third transistor is coupled to the first reference voltage signal terminal.

In some possible implementations, the second control sub-circuit includes: a fourth transistor, a fifth transistor, and a first capacitor;
a gate of the fourth transistor is coupled to the second control signal terminal, a first electrode of the fourth transistor is coupled to the data signal terminal, and a second electrode of the fourth transistor is coupled to the first node;
a gate of the fifth transistor is coupled to the third control signal terminal, a first electrode of the fifth transistor is coupled to the first node, and a second electrode of the fifth transistor is coupled to the second reference voltage signal terminal; and
a first electrode of the first capacitor is coupled to the first power supply terminal, and a second electrode of the first capacitor is coupled to the first node.

In some possible implementations, the first control sub-circuit includes: a sixth transistor, a seventh transistor, an eighth transistor, a ninth transistor, a tenth transistor, and a second capacitor;
a gate of the sixth transistor is coupled to the first control signal terminal, a first electrode of the sixth transistor is coupled to the light-emitting device, and a second electrode of the sixth transistor is coupled to the first initialization signal terminal;
a gate of the seventh transistor is coupled to the first light-emitting control signal terminal, a first electrode of the seventh transistor is coupled to the first power supply terminal, and a second electrode of the seventh transistor is coupled to the first electrode of the drive transistor;
a gate of the eighth transistor is coupled to the second light-emitting control signal terminal, a first electrode of the eighth transistor is coupled to the second electrode of the drive transistor, and a second electrode of the eighth transistor is coupled to the light-emitting device;
a gate of the ninth transistor is coupled to the third control signal terminal, a first electrode of the ninth transistor is coupled to the gate of the drive transistor, and a second electrode of the ninth transistor is coupled to the second electrode of the drive transistor;
a gate of the tenth transistor is coupled to the fourth control signal terminal, a first electrode of the tenth transistor is coupled to the gate of the drive transistor, and a second electrode of the tenth transistor is coupled to the second initialization signal terminal; and
a first electrode of the second capacitor is coupled to the first node, and a second electrode of the second capacitor is coupled to the gate of the drive transistor.

Embodiments of the present disclosure also provide a display apparatus including the pixel circuit as described above.

Embodiments of the present disclosure also provide a driving method of the pixel circuit, including:
in a data writing stage: reducing, by the first control circuit, the leakage current of the gate of the drive transistor based on the signal from the leakage adjustment signal terminal; and controlling, by the second control circuit, the data voltage to be input into the gate of the drive transistor; and
in a light-emitting stage: reducing, by the first control circuit, the leakage current of the gate of the drive transistor based on the signal from the leakage adjustment signal terminal; and controlling, by the second control circuit, the drive transistor to generate the operating current to drive the light-emitting device to emit light.

### BRIEF DESCRIPTION OF FIGURES

FIG. 1 shows a schematic structural diagram of some pixel circuits provided by embodiments of the present disclosure.

FIG. 2 shows a schematic structural diagram of some other pixel circuits provided by embodiments of the present disclosure.

FIG. 3 shows a schematic structural diagram of yet some other pixel circuits provided by embodiments of the present disclosure.

FIG. 4A shows a timing chart of some signals provided by embodiments of the present disclosure.

FIG. 4B shows a timing chart of yet some other signals provided by embodiments of the present disclosure.

FIG. 5 shows a flowchart of a driving method provided by embodiments of the present disclosure.

FIG. 6 shows a schematic structural diagram of yet some other pixel circuits provided by embodiments of the present disclosure.

FIG. 7 shows a timing chart of yet some other signals provided by embodiments of the present disclosure.

FIG. 8 shows a timing chart of yet some other signals provided by embodiments of the present disclosure.

FIG. 9 shows a timing chart of yet some other signals provided by embodiments of the present disclosure.

FIG. 10 shows a timing chart of yet some other signals provided by embodiments of the present disclosure.

FIG. 11 shows a schematic structural diagram of yet some other pixel circuits provided by embodiments of the present disclosure.

FIG. 12 shows a schematic structural diagram of yet some other pixel circuits provided by embodiments of the present disclosure.

### DETAILED DESCRIPTION

In order to make the objectives, technical solutions and advantages of the embodiments of the present disclosure clearer, the technical solutions of the embodiments of the present disclosure will be described clearly and completely in the following in conjunction with the drawings of the embodiments of the present disclosure. Obviously, the described embodiments are a part of the embodiments of the present disclosure, and not all of the embodiments. In addition, the embodiments and the features in the embodiments of the present disclosure can be combined with each other without conflict. Based on the described embodiments of the present disclosure, all other embodiments obtained by a person of ordinary skill in the art without the need for creative labor are within the claimed scope of the present disclosure.

Unless otherwise defined, technical or scientific terms used in the present disclosure shall have the ordinary meaning understood by a person of ordinary skill in the field to which the present disclosure belongs. The terms “first”, “second”, and the like as used in the present disclosure do not indicate any order, number, or significance, but are only used to distinguish different components. The words “including” or “comprising” and the like are intended to mean that the component or object preceded by the word encompasses the components or objects listed after the word and their equivalents, and does not exclude other components or objects. Words such as “connected” or “coupled” are not limited to physical or mechanical connections, but may include electrical connections, whether direct or indirect.

It should be noted that the dimensions and shapes of the figures in the drawings do not reflect true proportions, but are intended to be illustrative of the invention only. And throughout the same or similar labeling denotes the same or similar elements or elements having the same or similar function.

In some embodiments of the present disclosure, the display apparatus provided by embodiments of the present disclosure may include a display panel. The display panel may include a base substrate. The base substrate may include a display region and a non-display region (i.e., a region in the base substrate other than the display region). The display region may include a plurality of pixel units arranged in an array. Exemplarily, each pixel unit includes sub-pixels of the same color or a plurality of sub-pixels of different colors. For example, the pixel unit may include a red sub-pixel(s), a green sub-pixel(s), and a blue sub-pixel(s), so that color mixing can be performed by red, green, and blue to achieve a color display. Alternatively, the pixel unit may include a red sub-pixel(s), a green sub-pixel(s), a blue sub-pixel(s), and a white sub-pixel(s), so that color mixing can be performed by red, green, blue, and white to achieve a color display. Of course, in practice, the light-emitting colors of the sub-pixels in the pixel unit may be designed and determined according to the actual application environment, and are not limited herein. The following is an example of a pixel unit including a red sub-pixel, a green sub-pixel, and a blue sub-pixel.

In some embodiments of the present disclosure, a pixel circuit may be included in each sub-pixel, and the pixel circuit may include a drive transistor(s) and a light-emitting device(s) to control the light-emitting device to emit light, so as to enable the display panel to realize the function of image display. However, in the case of low-frequency driving, due to leakage and hysteresis problems at the gate of the drive transistor, after a longer operating time, the voltage at the gate of the drive transistor is caused to gradually change, and thus the brightness of the display will change. When different driving frequencies are switched, the problem of low gray-scale flickering occurs. Moreover, due to the process, aging, and other reasons, the threshold voltage Vth of the drive transistor may drift, which affects the generated drive current and affects the display.

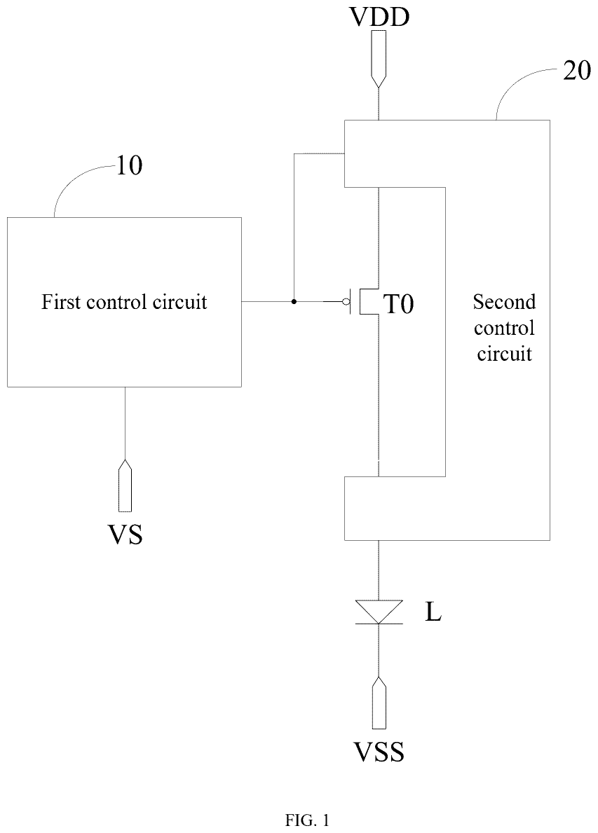

A pixel circuit provided by embodiments of the present disclosure, as shown in FIG. 1, includes: a light-emitting device L, a drive transistor TO, a first control circuit 10, and a second control circuit 20.

The drive transistor TO is coupled to the light-emitting device L and is configured to, based on a data voltage, generate an operating current to drive the light-emitting device L.

The first control circuit 10 is coupled to a gate of the drive transistor TO and is configured to, based on a signal from a leakage adjustment signal terminal VS, reduce a leakage current of the gate of the drive transistor TO.

The second control circuit 20 is coupled to the drive transistor TO and the light-emitting device L respectively, and is configured to reset the drive transistor TO and the light-emitting device L, control the data voltage to be input into the gate of the drive transistor TO, and control the drive transistor T0 to generate the operating current to drive the light-emitting device L to emit light.

In the pixel circuit provided by the embodiments of the present disclosure, the leakage current of the gate of the drive transistor can be reduced based on the signal from a leakage adjustment signal terminal by providing the first control circuit coupled to the gate of the drive transistor, thereby mitigating the problem of a flicker in a low gray-scale display. The second control circuit is provided to reset the drive transistor and the light-emitting device before driving the light-emitting device to emit light, control the data voltage to be input to the gate of the drive transistor, and control the drive transistor to generated the operating current to drive the light-emitting device to emit light, so as to reduce the hysteresis effect of the drive transistor, thereby mitigating the problem of a flicker in a high gray-scale display.

The pixel circuit provided in the embodiments of the present disclosure can be applied to a display panel driven by different refresh frequencies. Since the pixel circuit provided in the embodiments of the present disclosure can simultaneously mitigate the problem of the flicker in the high gray-scale display and the low gray-scale display, when switching between different refresh frequencies, the problem such as the flicker is reduced, and the display effect of the product is improved. Moreover, in order to reduce power consumption, the pixel circuit provided by the embodiments of the present disclosure can be applied in a case of driving at a lower refresh frequency (e.g., 1 Hz, 30 Hz, etc.). Additionally, in order to improve the display effect, the pixel circuit provided by the embodiments of the present disclosure may be applied in a case of driving at a higher refresh frequency (e.g., 60 Hz, 90 Hz, 120 Hz, 240 Hz, etc.).

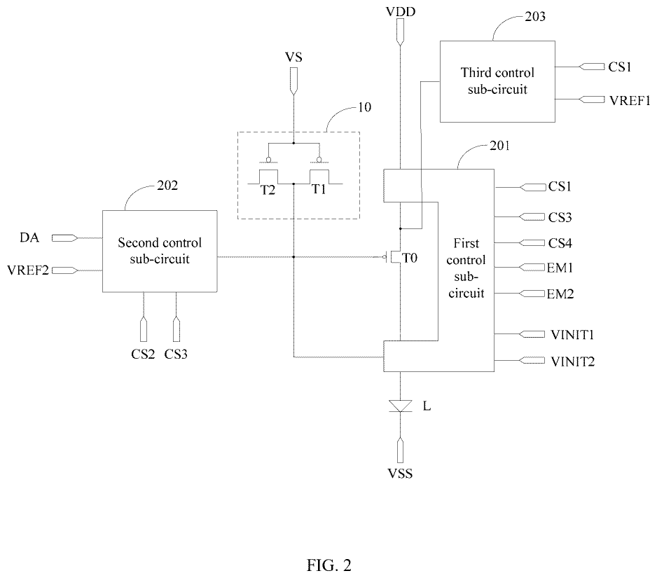

In some embodiments of the present disclosure, as shown in FIGS. 1 and 2, the second control circuit 20 includes: a first control sub-circuit 201, a second control sub-circuit 202, and a third control sub-circuit 203.

The first control sub-circuit 201 is configured to provide a signal from a first initialization signal terminal VINIT1 to the light-emitting device L in response to a signal from a first control signal terminal CS1, bring a first power supply terminal VDD into conduction with a first electrode of the drive transistor T0 in response to a signal from a first light-emitting control signal terminal EM1, bring a second electrode of the drive transistor T0 into conduction with the light-emitting device L in response to a signal from a second light-emitting control signal terminal EM2, bring the gate of the drive transistor T0 into conduction with the second electrode of the drive transistor T0 in response to a signal from a third control signal terminal CS3, and provide a signal from a second initialization signal terminal VINIT2 to the gate of the drive transistor T0 in response to a signal from a fourth control signal terminal CS4.

The second control sub-circuit 202 is configured to provide a data voltage Vda at a data signal terminal DA to the first node N1 in response to a signal from a second control signal terminal CS2, and provide a signal from a second reference voltage signal terminal VREF2 to the first node N1 in response to the signal from the third control signal terminal CS3.

The third control sub-circuit 203 is configured to provide a signal from a first reference voltage signal terminal VREF1 to the first electrode of the drive transistor T0 in response to the signal from the first control signal terminal CS1.

In some embodiments of the present disclosure, as shown in FIG. 2, the first electrode of the light-emitting device L may be coupled to the first control sub-circuit 201, and the second electrode of the light-emitting device L may be coupled to a second power supply terminal VSS. Additionally, the first electrode of the light-emitting device L may be the anode thereof and the second electrode is the cathode thereof. Exemplarily, the light-emitting device L may be an electroluminescent diode. For example, the light-emitting device L may include at least one of: a micro light-emitting diode (Micro LED), an organic light-emitting diode (OLED), and a quantum dot light-emitting diode (QLED). In practice, the specific structure of the light-emitting device L can be designed and determined according to the actual application environment, and is not limited herein.

In some embodiments of the present disclosure, the first power supply terminal VDD may be configured to be loaded with a first supply voltage that is constant, and the first supply voltage is generally of a positive value. As well, the second power supply terminal VSS may be loaded with a second supply voltage that is constant, and the second supply voltage may generally be a ground voltage or of a negative value. In practice, the specific values of the first power supply voltage and the second power supply voltage may be designed and determined according to the actual application environment, and are not limited herein.

In some embodiments of the present disclosure, as shown in FIGS. 1 and 2, the drive transistor T0 may be provided as a P-type transistor; and the first electrode of the drive transistor T0 may be its source and the second electrode of the drive transistor T0 may be its drain. When the drive transistor T0 is in a saturated state, a current flows from the source of the drive transistor T0 to the drain of the drive transistor T0. Of course, the drive transistor T0 may also be provided as an N-type transistor, and is not limited herein.

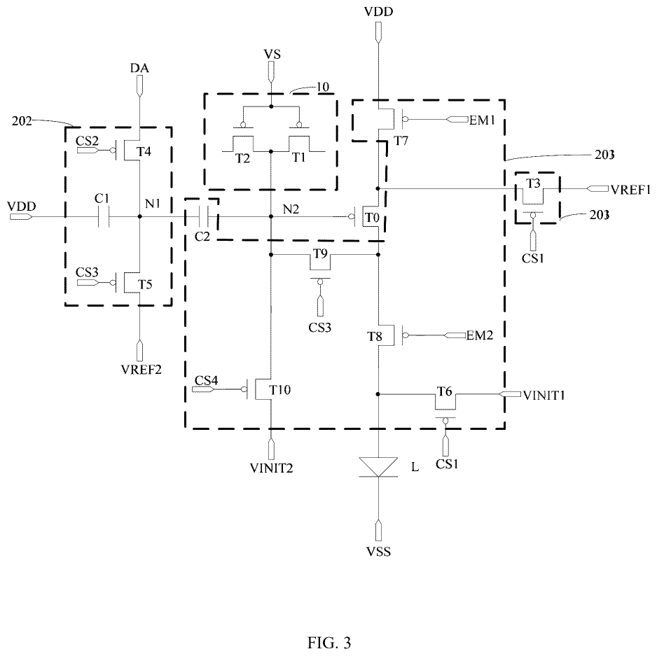

In some embodiments of the present disclosure, as shown in FIG. 3, the first control circuit 10 includes: a first transistor T1 and a second transistor T2. A gate of the first transistor T1 is coupled to the leakage adjustment signal terminal VS, a first electrode of the first transistor T1 floats, and a second electrode of the first transistor T1 is coupled to the gate of the drive transistor T0. A gate of the second transistor T2 is coupled to the leakage adjustment signal terminal VS, a first electrode of the second transistor T2 floats, and a second electrode of the second transistor T2 is coupled to the gate of the drive transistor T0. In this manner, by setting the first transistor T1 and the second transistor T2 and coupling both the first transistor T1 and the second transistor T2 to the leakage adjustment signal terminal VS, the leakage current at the gate of the drive transistor T0 can be reduced when a voltage is loaded at the leakage adjustment signal terminal VS.

Exemplarily, the first transistor T1 and the second transistor T2 may be provided as P-type transistors. Of course, in practice, the first transistor and the second transistor may also be provided as N-type transistors and are not limited herein.

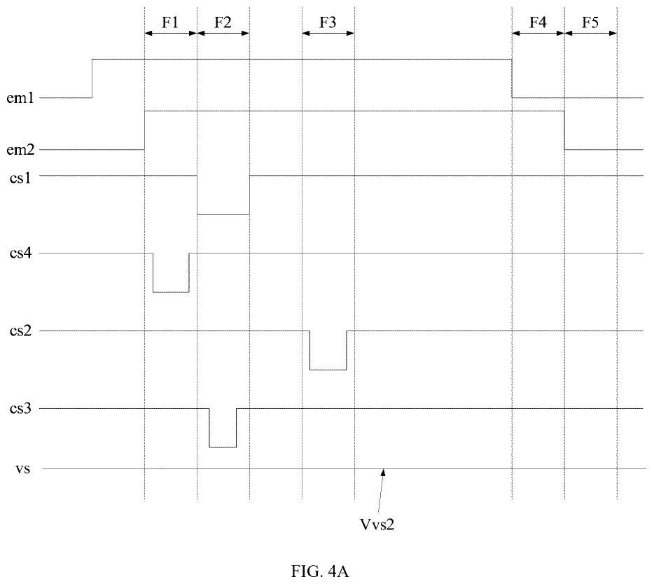

In some examples, in the same one display frame, when resetting the gate of the drive transistor T0, a voltage of the signal from the leakage adjustment signal terminal VS is a first voltage Vvs1, and when inputting the data voltage Vda into the gate of the drive transistor T0, a voltage of the signal from the leakage adjustment signal terminal VS is a second voltage Vvs2. it is possible to make the second voltage Vvs2 equal to the first voltage Vvs1. In this manner, it is possible to make the voltage of the signal vs from the leakage adjustment signal terminal VS be a fixed voltage in one display frame. For example, as shown in FIG. 4A, the voltage of the signal vs from the leakage conditioning signal terminal VS is the second voltage Vvs2.

Exemplarily, in different display frames, it is possible to make the first voltages Vvs1 be the same, so that it is no need to frequently adjust the first voltage Vvs1, thereby reducing the power consumption.

Exemplarily, in different display frames, the second voltages Vvs2 may be made greater than third voltages Vvs3. The third voltage Vvs3 is (Vda−Vth), in which Vda represents the data voltage, and Vth represents a threshold voltage of the drive transistor. For example, if (Vda−Vth) is about 0 to 1 V, the second voltage Vvs2 may be set to 2 V. Optionally, Vda may be the data voltage corresponding to a larger gray scale or a maximum gray scale.

Exemplarily, in different display frames, it is possible to make the second voltages Vvs2 be the same, so that it is no need to frequently adjust the second voltage Vvs2, thereby reducing the power consumption. Based on this, in the different display frames, it is possible to make the voltages of the signals vs from the leakage adjustment signal terminal VS be a fixed voltage, so that it is no need to frequently adjust the voltage of the signal vs from the leakage adjustment signal terminal VS, thereby reducing the power consumption.

Exemplarily, in the different display frames, it is possible to make the second voltages Vvs2 increase with the increase of the third voltages Vvs3, so that the second voltage Vvs2 may be adjusted with the third voltage Vvs3 to further reduce the leakage current. Based on this, in different display frames, the voltages of the signals vs at the leakage adjustment signal terminal VS can be made to be an alternating voltage to further reduce the leakage current.

In other examples, exemplarily, in the same one display frame, a voltage of the signal vs from the leakage adjustment signal terminal VS is a first voltage Vvs1 when resetting the gate of the drive transistor T0, and a voltage of the signal vs from the leakage adjustment signal terminal VS is a second voltage Vvs2 when inputting the data voltage into the gate of the drive transistor T0. It is possible to make the second voltage Vvs2 greater than the first voltage Vvs1. In this manner, it is possible to make the voltage of the signal vs from the leakage adjustment signal terminal VS be an alternating voltage in one display frame. For example, as shown in FIG. 4B, the voltage of the signal vs from the leakage conditioning signal terminal VS has a second voltage Vvs2 and a first voltage Vvs1.

Exemplarily, in different display frames, it is possible to make the first voltages Vvs1 be the same, so that it is no need to frequently adjust the first voltage Vvs1, thereby reducing the power consumption.

Exemplarily, in different display frames, the second voltages Vvs2 may be made greater than the third voltages Vvs3. The third voltage Vvs3 is (Vda−Vth), in which Vda represents the data voltage, and Vth represents a threshold voltage of the drive transistor. For example, if (Vda-Vth) is about 0 to 1V, the second voltage Vvs2 may be set to 2V. Optionally, Vda may be the data voltage corresponding to a larger gray scale or a maximum gray scale.

Exemplarily, in different display frames, the second voltages Vvs2 may be made the same, so that it is no need to frequently adjust the second voltage Vvs2, thereby reducing the power consumption.

Exemplarily, in different display frames, the second voltages Vvs2 can also be made to increase with the increase of the third voltages Vvs3, so that the second voltages Vvs2 can be adjusted with the third voltages Vvs3, thereby further reducing the leakage current.

In some embodiments of the present disclosure, as shown in FIG. 3, the third control sub-circuit 203 includes: a third transistor T3; a gate of the third transistor T3 is coupled to the first control signal terminal CS1, a first electrode of the third transistor T3 is coupled to the first electrode of the drive transistor T0, and a second electrode of the third transistor T3 is coupled to the first reference voltage signal terminal VREF1.

Exemplarily, the third transistor T3 is turned on under the control of the effective level of the first control signal from the first control signal terminal CS1 and is turned off under the control of the invalid level of the first control signal. Optionally, the third transistor T3 may be provided as a P-type transistor, so that the effective level of the first control signal may be a low level and the invalid level of the first control signal may be a high level. Alternatively, the third transistor T3 may be provided as an N-type transistor, then the effective level of the first control signal may be a high level, and the invalid level of the first control signal may be a low level.

In some embodiments of the present disclosure, as shown in FIG. 3, the second control sub-circuit 202 includes: a fourth transistor T4, a fifth transistor T5, and a first capacitor C1. A gate of the fourth transistor T4 is coupled to the second control signal terminal CS2, a first electrode of the fourth transistor T4 is coupled to the data signal terminal DA, and a second electrode of the fourth transistor T4 is coupled to the first node N1;
a gate of the fifth transistor T5 is coupled to the third control signal terminal CS3, a first electrode of the fifth transistor T5 is coupled to the first node N1, and a second electrode of the fifth transistor T5 is coupled to the second reference voltage signal terminal VREF2; and
a first electrode of the first capacitor C1 is coupled to the first power supply terminal VDD, and a second electrode of the first capacitor C1 is coupled to the first node N1.

Exemplarily, the fourth transistor T4 is turned on under the control of an effective level of the second control signal from the second control signal terminal CS2 and is turned off under the control of an invalid level of the second control signal. Optionally, the fourth transistor T4 may be provided as a P-type transistor, so that the effective level of the second control signal may be a low level and the invalid level of the second control signal may be a high level. Alternatively, the fourth transistor T4 may be provided as an N-type transistor, so that the effective level of the second control signal may be a high level and the invalid level of the second control signal may be a low level.

Exemplarily, the fifth transistor T5 is turned on under the control of the effective level of the third control signal from the third control signal terminal CS3 and is turned off under the control of the invalid level of the third control signal. Optionally, the fifth transistor T5 may be provided as a P-type transistor, so that the effective level of the third control signal may be a low level and the invalid level of the third control signal may be a high level. Alternatively, the fifth transistor T5 may be provided as an N-type transistor, then the effective level of the third control signal may be a high level and the invalid level of the third control signal may be a low level.

In some embodiments of the present disclosure, as shown in FIG. 3, the first control sub-circuit 201 includes: a sixth transistor T6, a seventh transistor T7, an eighth transistor T8, a ninth transistor T9, a tenth transistor T10, and a second capacitor C2; a gate of the sixth transistor T6 is coupled to the first control signal terminal CS1, a first electrode of the sixth transistor T6 is coupled to the light-emitting device L, and a second electrode of the sixth transistor T6 is coupled to the first initialization signal terminal VINIT1;
a gate of the seventh transistor T7 is coupled to the first light-emitting control signal terminal EM1, a first electrode of the seventh transistor T7 is coupled to the first power supply terminal VDD, and a second electrode of the seventh transistor T7 is coupled to the first electrode of the drive transistor T0;
a gate of the eighth transistor T8 is coupled to the second light-emitting control signal terminal EM2, a first electrode of the eighth transistor T8 is coupled to the second electrode of the drive transistor T0, and a second electrode of the eighth transistor T8 is coupled to the light-emitting device L;
a gate of the ninth transistor T9 is coupled to the third control signal terminal CS3, a first electrode of the ninth transistor T9 is coupled to the gate of the drive transistor T0, and a second electrode of the ninth transistor T9 is coupled to the second electrode of the drive transistor T0;
a gate of the tenth transistor T10 is coupled to the fourth control signal terminal CS4, a first electrode of the tenth transistor T10 is coupled to the gate of the drive transistor T0, and a second electrode of the tenth transistor T10 is coupled to the second initialization signal terminal VINIT2; and
a first electrode of the second capacitor C2 is coupled to the first node N1, and a second electrode of the second capacitor C2 is coupled to the gate of the drive transistor T0.

Exemplarily, the sixth transistor T6 is turned on under the control of an effective level of the first control signal from the first control signal terminal CS1 and is turned off under the control of an invalid level of the first control signal. Optionally, the sixth transistor T6 may be provided as a P-type transistor, so that the effective level of the first control signal may be a low level and the invalid level of the first control signal may be a high level. Alternatively, the sixth transistor T6 may be provided as an N-type transistor, then the effective level of the first control signal may be a high level and the invalid level of the first control signal may be a low level.

Exemplarily, the seventh transistor T7 is turned on under the control of the effective level of the first light-emitting control signal from the first light-emitting control signal terminal EM1 and is turned off under the control of the invalid level of the first light-emitting control signal. Optionally, the seventh transistor T7 may be provided as a P-type transistor, so that the effective level of the first light-emitting control signal may be a low level and the invalid level of the first light-emitting control signal may be a high level. Alternatively, the seventh transistor T7 may be provided as an N-type transistor, so that the effective level of the first light-emitting control signal may be a high level and the invalid level of the first light-emitting control signal may be a low level.

Exemplarily, the eighth transistor T8 is turned on under the control of the effective level of the second light-emitting control signal from the second light-emitting control signal terminal EM2 and is turned off under the control of the invalid level of the second light-emitting control signal. Optionally, the eighth transistor T8 may be provided as a P-type transistor, so that the effective level of the second light-emitting control signal may be a low level and the invalid level of the second light-emitting control signal may be a high level. Alternatively, the eighth transistor T8 may be provided as an N-type transistor, so that the effective level of the second light-emitting control signal may be a high level and the invalid level of the second light-emitting control signal may be a low level.

Exemplarily, the ninth transistor T9 is turned on under the control of the effective level of the third control signal from the third control signal terminal CS3 and is turned off under the control of the invalid level of the third control signal. Optionally, the ninth transistor T9 may be provided as a P-type transistor, so that the effective level of the third control signal may be a low level and the invalid level of the third control signal may be a high level. Alternatively, the ninth transistor T9 may be provided as an N-type transistor, so that the effective level of the third control signal may be a high level and the invalid level of the third control signal may be a low level.

Exemplarily, the tenth transistor T10 is turned on under the control of the effective level of the fourth control signal from the fourth control signal terminal CS4 and is turned off under the control of the invalid level of the fourth control signal. Optionally, the tenth transistor T10 may be provided as a P-type transistor, so that the effective level of the fourth control signal may be a low level and the invalid level of the fourth control signal may be a high level. Alternatively, the tenth transistor T10 may be provided as an N-type transistor, so that the effective level of the fourth control signal may be a high level and the invalid level of the fourth control signal may be a low level.

In specific implementation, the first electrode of the transistor may be used as its source and the second electrode as its drain according to the type of the transistor and the signal of its gate; or, conversely, the first electrode of the transistor may be used as its drain and the second electrode may be used as its source, which may be designed and determined according to the actual application environment, and specifically no specific distinction is made herein.

The above are only examples to illustrate the specific structure of each circuit in the pixel circuit provided by the embodiments of the present disclosure, and in the specific implementation, the specific structures of the above circuit are not limited to the above structures provided by the embodiments of the present disclosure, but may also be other structures known to the person skilled in the art, which are all within the scope of the protection of the present disclosure, and are specifically not limited herein.

The following is an example of each of the above-described transistors being of the P-type. Exemplarily, a timing chart of signals of the pixel circuit shown in FIG. 3 is shown in FIG. 4A with FIG. 4B. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, cs3 represents a third control signal from the third control signal terminal CS3, and cs4 represents a fourth control signal from the fourth control signal terminal CS4. Exemplarily, if any two of the first control signal cs1, the second control signal cs2, the third control signal cs3, and the fourth control signal cs4 are not the same, the first control signal terminal CS1, the second control signal terminal CS2, the third control signal terminal CS3, and the fourth control signal terminal CS4 may be set as different signal terminals.

Exemplarily, as shown in FIG. 4A with FIG. 4B, in one display frame, an effective level (e.g., low level) of the first control signal cs1 from the first control signal terminal CS1 occurs before an effective level (e.g., low level) of the second control signal cs2 from the second control signal terminal CS2, and the effective level (e.g., low level) of the first control signal cs1 from the first control signal terminal CS1 has an overlapping region with the effective level (e.g., low level) of the third control signal cs3 from the third control signal terminal CS3. Additionally, an effective level (e.g., low level) of the fourth control signal cs4 from the fourth control signal terminal CS4 occurs before the effective level (e.g., low level) of the first control signal cs1 from the first control signal terminal CS1.

Exemplarily, the effective level (e.g., low level) of the first control signal cs1 from the first control signal terminal CS1 has an overlapping region with the effective level (e.g., low level) of the third control signal cs3 from the third control signal terminal CS3. Then, the third transistor T3, the sixth transistor T6, the fifth transistor T5, and the ninth transistor T9 are all turned on during the time duration of this overlapping region.

Exemplarily, a gate drive circuit and a light-emitting control circuit may be provided in the non-display region of the base substrate to drive each transistor in the pixel circuit.

In some examples, combining FIG. 3 with FIG. 4A and FIG. 4B, three gate drive circuits (each gate drive circuit may include a plurality of cascaded shift register units) and one light-emitting control circuit (the light-emitting control circuit may include a plurality of cascaded shift register units) may be provided in the non-display region. The first control signal cs1 from the first control signal terminal CS1 may be input using the 1^{st} gate drive circuit among the three gate drive circuits. The third control signal cs3 from the third control signal terminal CS3 may be input using the 2^{nd} gate drive circuit among the three gate drive circuits. The second control signal cs2 from the second control signal terminal CS2 and the fourth control signal cs4 from the fourth control signal terminal CS4 may be input using the 3^{rd} gate drive circuit among the three gate drive circuits. Moreover, the first light-emitting control signal em1 from the first light-emitting control signal terminal EM1 and the second light-emitting control signal em2 from the second light-emitting control signal terminal EM2 may be adopted from this light-emitting control circuit.

Exemplarily, for the first control signal cs1 to the fourth control signal cs4 received by the pixel circuits in the n^{th} row of sub-pixels, the first control signal cs1 may be a signal input by the n^{th} stage shift register unit in the 1^{st} gate drive circuit. The third control signal cs3 may be a signal input by the n^{th} stage shift register unit in the 2^{nd} gate drive circuit. As well, the fourth control signal cs4 may be a signal (e.g., Gate (n−3)) input by the (n−3)^{th} stage shift register unit in the 3^{rd} gate drive circuit, and the second control signal cs2 is a signal (e.g., Gate (n)) input by the n^{th} stage shift register unit in the 3^{rd} gate drive circuit. As well, the first light-emitting control signal em1 from the first light-emitting control signal terminal EM1 may be a signal input by the (n−1)^{th} stage shift register unit in the light-emitting control circuit, and the second light-emitting control signal em2 from the second light-emitting control signal terminal EM2 may be a signal input by the n^{th} stage shift register unit in the light-emitting control circuit.

In other examples, combining FIG. 3 with FIG. 4A and FIG. 4B, two gate drive circuits (each gate drive circuit may include a plurality of cascaded shift register units) and one light-emitting control circuit (the light-emitting control circuit may include a plurality of cascaded shift register units) may be provided in the non-display region, which can save one gate drive circuit and reduce the space occupied by the non-display region. Moreover, the first light-emitting control signal em1 from the first light-emitting control signal terminal EM1 and the second light-emitting control signal em2 from the second light-emitting control signal terminal EM2 can be adopted from this light-emitting control circuit.

Exemplarily, the first control signal cs1 from the first control signal terminal CS1 may be input using the 1^{st} gate drive circuit of the two gate drive circuits. The second control signal cs2 from the second control signal terminal CS2, the third control signal cs3 from the third control signal terminal CS3, and the fourth control signal cs4 from the fourth control signal terminal CS4 may be input using the 2^{nd} gate drive circuit of the two gate drive circuits. Exemplarily, for the first control signal cs1 to the fourth control signal cs4 received by the pixel circuits in the n^{th} row of sub-pixels, the first control signal cs1 may be a signal input by the n^{th} stage shift register unit in the 1^{st} gate drive circuit. As well, the fourth control signal cs4 may be a signal (e.g., Gate(n−3)) input by the (n−3)^{th} stage shift register unit in the 2^{nd} gate drive circuit, the third control signal cs3 may be a signal (e.g., Gate(n−2)) input by the (n−2)^{th} stage shift register unit in the 2^{nd} gate drive circuit, and the second control signal cs2 is a signal (e.g., Gate (n)) input by the n^{th} stage shift register unit in the 2^{nd} gate drive circuit. As well, the first light-emitting control signal em1 from the first light-emitting control signal terminal EM1 may be a signal input by the (n−1)^{th} stage shift register unit in the light-emitting control circuit, and the second light-emitting control signal em2 from the second light-emitting control signal terminal EM2 may be a signal input by the n^{th} stage shift register unit in the light-emitting control circuit.

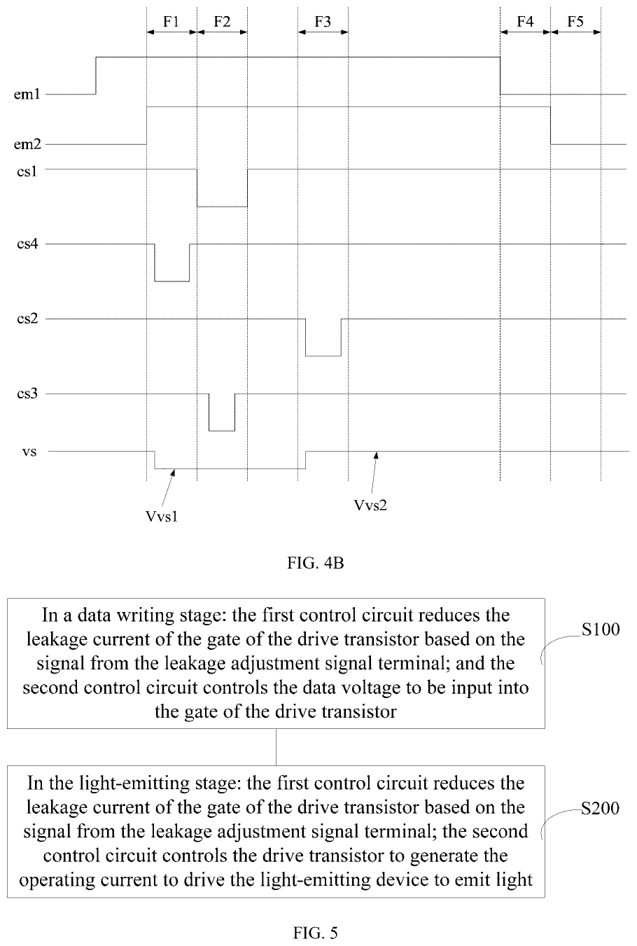

As shown in FIG. 5, a driving method of the pixel circuit provided by embodiments of the present disclosure may include the following steps.

S100, in a data writing stage: the first control circuit reduces the leakage current of the gate of the drive transistor based on the signal from the leakage adjustment signal terminal; and the second control circuit controls the data voltage to be input into the gate of the drive transistor.

S200, in the light-emitting stage: the first control circuit reduces the leakage current of the gate of the drive transistor based on the signal from the leakage adjustment signal terminal; the second control circuit controls the drive transistor to generate the operating current to drive the light-emitting device to emit light.

Hereinafter, the structure of the pixel circuit shown in FIG. 3 is taken as an example, and in combination with the timing chart of signals shown in FIG. 4A, the working process of the pixel circuit provided by the embodiments of the present disclosure within one display frame is described. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, cs3 represents a third control signal from the third control signal terminal CS3, cs4 represents a fourth control signal from the fourth control signal terminal CS4.

In the first stage F1, the seventh transistor T7 is turned off under the control of the high level of the first light-emitting control signal em1, the eighth transistor T8 is turned off under the control of the high level of the second light-emitting control signal em2, the third transistor T3 and the sixth transistor T6 are turned off under the control of the high level of the first control signal cs1, the tenth transistor T10 is turned on under the control of the low level of the fourth control signal cs4, the fourth transistor T4 is turned off under the control of the high level of the second control signal cs2, and the fifth transistor T5 and the ninth transistor T9 are turned off under the control of the high level of the third control signal cs3. The tenth transistor T10 which has been turned on provides the signal from the second initialization signal terminal VINIT2 to the gate of the drive transistor T0 (i.e., the second node N2) to reset the gate of the drive transistor T0. Then, VN2=Vinit2, here VN2 represents the voltage of the second node N2 and Vinit2 represents the voltage output from the second initialization signal terminal VINIT2.

In the second stage F2, the seventh transistor T7 is turned off under the control of the high level of the first light-emitting control signal em1, the eighth transistor T8 is turned off under the control of the high level of the second light-emitting control signal em2, the third transistor T3 and the sixth transistor T6 are turned on under the control of the low level of the first control signal cs1, the tenth transistor T10 is turned off under the control of the high level of the fourth control signal cs4, the fourth transistor T4 is turned off under the control of the high level of the second control signal cs2, and the fifth transistor T5 and the ninth transistor T9 are turned on under the control of the low level of the third control signal cs3. The turned-on third transistor T3 provides the signal from the first reference voltage signal terminal VREF1 to the first electrode of the drive transistor T0 to reset the first electrode of the drive transistor T0. The turned-on sixth transistor T6 provides the signal from the first initialization signal terminal VINIT1 to the light-emitting device L to reset the light-emitting device L. The turned-on fifth transistor T5 provides the signal from the second reference voltage signal terminal VREF2 to the first node N1. Then, VN1=Vref2, here VN1 represents the voltage of the first node N1 and Vref2 represents the voltage output from the second reference voltage signal terminal VREF2. The turned-on ninth transistor T9 brings the gate of the drive transistor T0 into conduction with the second electrode of the drive transistor T0, then, VN2=Vth+Vref1, here, Vth represents the threshold voltage of the drive transistor T0, and Vref1 represents the voltage output from the first reference voltage signal terminal VREF1.

In the third stage F3, the seventh transistor T7 is turned off under the control of the high level of the first light-emitting control signal em1, the eighth transistor T8 is turned off under the control of the high level of the second light-emitting control signal em2, the third transistor T3 and the sixth transistor T6 are turned off under the control of the high level of the first control signal cs1, the tenth transistor T10 is turned off under the control of the high level of the fourth control signal cs4, the fourth transistor T4 is turned on under the control of the low level of the second control signal cs2, and the fifth transistor T5 and the ninth transistor T9 are turned off under the control of the high level of the third control signal cs3. The turned-on fourth transistor T4 inputs the data voltage Vda of the data signal terminal DA to the first node N1, then the voltage VN1 changes from Vref2 to Vda. The voltage VN2 changes from (Vth+Vref1) to:

$$( Vth + Vref 1 ) + \frac{{C}_{2}}{( {C}_{2} + Cgs\_T10 + Cgs\_T9 + Cgs\_T0 + Cgs\_T1 + Cgs\_T2 )} * ( Vda - Vref 2 ) .$$

here, C2 represents the capacitance value of the second capacitor C2, Cgs_T10 represents the capacitance value of the tenth transistor T10, Cgs_T9 represents the capacitance value of the ninth transistor T9, Cgs_T0 represents the capacitance value of the drive transistor T0, Cgs_T1 represents the capacitance value of the first transistor T1, and Cgs_T2 represents the capacitance value of the second transistor T2. Moreover, the leakage current of the gate of the drive transistor T0 is reduced due to the effect of the signal from the leakage adjustment signal terminal VS, which may further maintain the stability of the voltage of the gate of the drive transistor T0.

In the fourth stage F4, the seventh transistor T7 is turned on under the control of the low level of the first light-emitting control signal em1, the eighth transistor T8 is turned off under the control of the high level of the second light-emitting control signal em2, the third transistor T3 and the sixth transistor T6 are turned off under the control of the high level of the first control signal cs1, the tenth transistor T10 is turned off under the control of the high level of the fourth control signal cs4, the fourth transistor T4 is turned off under the control of the high level of the second control signal cs2, and the fifth transistor T5 and the ninth transistor T9 are turned off under the control of the high level of the third control signal cs3. The turned-on seventh transistor T7 provides the signal of the first power supply terminal VDD to the first electrode of the drive transistor T0. Moreover, the leakage current of the gate of the drive transistor T0 is reduced due to the effect of the signal of the leakage adjustment signal terminal VS, which may further maintain the stability of the voltage of the gate of the drive transistor T0.

In the fifth stage F5, the seventh transistor T7 is turned on under the control of the low level of the first light-emitting control signal em1, the eighth transistor T8 is turned on under the control of the low level of the second light-emitting control signal em2, the third transistor T3 and the sixth transistor T6 are turned off under the control of the high level of the first control signal cs1, the tenth transistor T10 is turned off under the control of the high level of the fourth control signal cs4, the fourth transistor T4 is turned off under the control of the high level of the second control signal cs2, and the fifth transistor T5 and the ninth transistor T9 are turned off under the control of the high level of the third control signal cs3. The turned-on seventh transistor T7 provides the signal of the first power supply terminal VDD to the first electrode of the drive transistor T0, so that the voltage at the first electrode of the drive transistor T0 is the first power supply voltage Vdd. The turned-on eighth transistor T8 brings the second electrode of the drive transistor T0 into conduction with the light-emitting device L, so that the drive transistor T0 generates a drive current Ids for driving the light-emitting device L to emit light, and controls the light-emitting device L to emit light. The drive transistor T0 generates the operating current Ids for driving the light-emitting device L to emit light, and, Ids satisfies the following formula:

$$Ids = {k [ ( Vref 1 + \frac{{C}_{2}}{( {C}_{2} + {Cgs}_{T 10} + {Cgs}_{T 9} + {Cgs}_{T 0} + {Cgs}_{T 1} + {Cgs}_{T 2} )} * ( Vda - Vref ) - Vdd ]}^{2} .$$

Here,

$$k = \frac{1}{2} * μ * {C}_{o x} * \frac{W}{L} ,$$

L represents a length of a channel of the drive transistor T0, W represents a width of the channel of the drive transistor T0, COX represents a capacitance per unit area of a gate insulating layer of the drive transistor T0, represents a mobility of the drive transistor T0, and Vdd represents the voltage outputted from the first power supply terminal VDD. Moreover, the leakage current of the gate of the drive transistor T0 is reduced due to the effect of the signal of the leakage adjustment signal terminal VS, which may further maintain the stability of the voltage of the gate of the drive transistor T0.

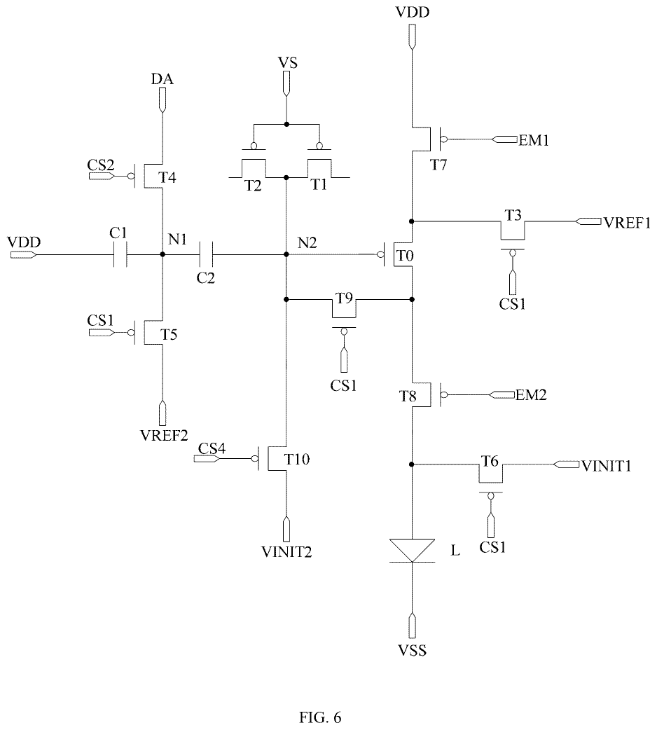

Embodiments of the present disclosure provide other pixel circuits, as shown in FIG. 6, which are morphed with respect to the implementations in the above-described embodiments. Only the differences between the present embodiments and the above embodiments are described below, and their general similarities will not be repeated herein.

In some embodiments of the present disclosure, as shown in FIG. 6, the first control signal terminal CS1 and the third control signal terminal CS3 receive the same one signal to reduce the quantity of signal terminals and the quantity of wirings. Exemplarily, the gate of the fifth transistor T5 and the gate of the ninth transistor T9 are both coupled to the first control signal terminal CS1.

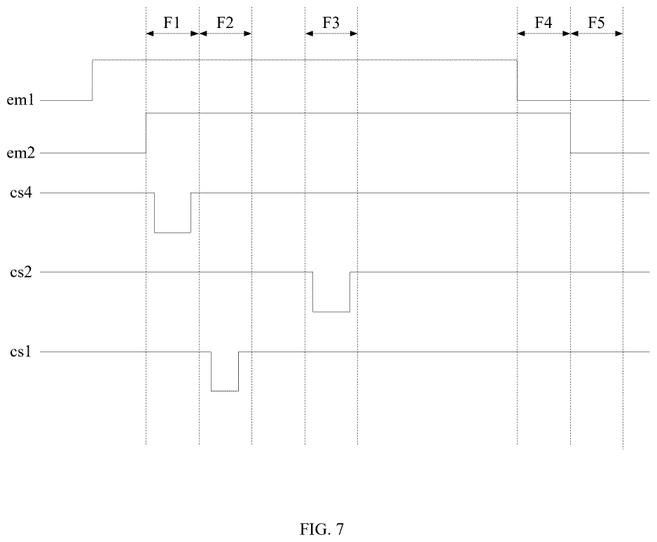

In some embodiments of the present disclosure, the pixel circuit shown in FIG. 6 corresponds to a timing chart of signals as shown in FIG. 7. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, and cs4 represents a fourth control signal from the fourth control signal terminal CS4. Exemplarily, if any two of the first control signal cs1, the second control signal cs2, and the fourth control signal cs4 are not the same, the first control signal terminal CS1, the second control signal terminal CS2, and the fourth control signal terminal CS4 may be set as different signal terminals.

Exemplarily, in one display frame, an effective level (e.g., low level) of the first control signal cs1 from the first control signal terminal CS1 occurs before an effective level (e.g., low level) of the second control signal cs2 from the second control signal terminal CS2. Additionally, an effective level (e.g., low level) of the fourth control signal cs4 from the fourth control signal terminal CS4 occurs before the effective level (e.g., low level) of the first control signal cs1 from the first control signal terminal CS1.

Exemplarily, a gate drive circuit and a light-emitting control circuit may be provided in the non-display region of the base substrate to drive each transistor in the pixel circuit.

In some examples, in conjunction with FIGS. 6 and 7, one gate drive circuit (the gate drive circuit may include a plurality of cascaded shift register units) and one light-emitting control circuit (the light-emitting control circuit may include a plurality of cascaded shift register units) may be provided in the non-display region. The first control signal cs1 from the first control signal terminal CS1, the second control signal cs2 from the second control signal terminal CS2, and the fourth control signal cs4 from the fourth control signal terminal CS4 may be input using this gate drive circuit. This saves the quantity of the gate drive circuit to be set and reduces the occupied space of the non-display region. Moreover, the first light-emitting control signal em1 from the first light-emitting control signal terminal EM1 and the second light-emitting control signal em2 from the second light-emitting control signal terminal EM2 may be adopted from this light-emitting control circuit.

Exemplarily, for the first control signal cs1 to the fourth control signal cs4 received by the pixel circuits in the n^{th} row of sub-pixels, the fourth control signal cs4 may be a signal (e.g., Gate(n−3)) input by the (n−3)^{th} stage shift register unit in this gate drive circuit, and the first control signal cs1 is a signal (such as Gate (n−2)) input by the (n−2)^{th} stage shift register unit in this gate drive circuit, and the second control signal cs2 is a signal (such as Gate (n)) input by the n^{th} stage shift register unit in this gate drive circuit. As well, the first light-emitting control signal em1 from the first light-emitting control signal terminal EM1 may be a signal input by the (n−1)^{th} stage shift register unit in the light-emitting control circuit, and the second light-emitting control signal em2 from the second light-emitting control signal terminal EM2 may be a signal input by the n^{th} stage shift register unit in the light-emitting control circuit.

In other examples, in conjunction with FIGS. 6 and 7, two gate drive circuits (each gate drive circuit may include a plurality of cascaded shift register units) and one light-emitting control circuit (the light-emitting control circuit may include a plurality of cascaded shift register units) may be arranged in the non-display region. Additionally, the first light-emitting control signal em1 from the first light-emitting control signal terminal EM1 and the second light-emitting control signal em2 from the second light-emitting control signal terminal EM2 may be adopted from the light-emitting control circuit.

Exemplarily, the first control signal cs1 from the first control signal terminal CS1 may be input using the 1^{st} gate drive circuit of the two gate drive circuits. The second control signal cs2 from the second control signal terminal CS2 and the fourth control signal cs4 from the fourth control signal terminal CS4 may be input using the 2^{nd} gate drive circuit of the 2 gate drive circuits. Exemplarily, for the first control signal cs1 to the fourth control signal cs4 received by the pixel circuits in the n^{th} row of sub-pixels, the first control signal cs1 may be a signal input by the n^{th} stage shift register unit in the 1^{st} gate drive circuit. As well, the fourth control signal cs4 may be a signal (e.g., Gate (n−3)) input by the (n−3)^{th} stage shift register unit in the 2^{nd} gate drive circuit, and the second control signal cs2 is a signal (e.g., Gate (n)) input by the n^{th} stage shift register unit in the 2^{nd} gate drive circuit. As well, the first light-emitting control signal em1 from the first light-emitting control signal terminal EM1 may be a signal input by the (n−1)^{th} stage shift register unit in the light-emitting control circuit, and the second light-emitting control signal em2 from the second light-emitting control signal terminal EM2 may be a signal input by the n^{th} stage shift register unit in the light-emitting control circuit.

The following describes the operating process of the pixel circuit provided in the embodiments of the present disclosure within a display frame, taking the structure of the pixel circuit shown in FIG. 6 as an example, in conjunction with a timing chart of signals shown in FIG. 7. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, and cs4 represents a fourth control signal from the fourth control signal terminal CS4.

In the first stage F1, the seventh transistor T7 is turned off under the control of the high level of the first light-emitting control signal em1, the eighth transistor T8 is turned off under the control of the high level of the second light-emitting control signal em2, the tenth transistor T10 is turned on under the control of the low level of the fourth control signal cs4, the fourth transistor T4 is turned off under the control of the high level of the second control signal cs2, and the third transistor T3, the sixth transistor T6, the fifth transistor T5, and the ninth transistor T9 are turned off under the control of the high level of the first control signal cs1. The turned-on tenth transistor T10 provides the signal of the second initialization signal terminal VINIT2 to the gate of the drive transistor T0 to reset the gate of the drive transistor T0. Then, VN2=Vinit2.

In the second stage F2, the seventh transistor T7 is turned off under the control of the high level of the first light-emitting control signal em1, the eighth transistor T8 is turned off under the control of the high level of the second light-emitting control signal em2, the tenth transistor T10 is turned off under the control of the high level of the fourth control signal cs4, the fourth transistor T4 is turned off under the control of the high level of the second control signal cs2, and the third transistor T3, the sixth transistor T6, the fifth transistor T5, and the ninth transistor T9 are turned on under the control of the low level of the first control signal cs1. The turned-on third transistor T3 provides the signal from the first reference voltage signal terminal VREF1 to the first electrode of the drive transistor T0 to reset the first electrode of the drive transistor T0. The turned-on sixth transistor T6 provides the signal from the first initialization signal terminal VINIT1 to the light-emitting device L to reset the light-emitting device L. The turned-on fifth transistor T5 provides the signal from the second reference voltage signal terminal VREF2 to the first node N1. Then, VN1=Vref2. The turned-on ninth transistor T9 brings the gate of the drive transistor T0 into conduction with the second electrode of the drive transistor T0, then VN2=Vth+Vref1.

In the third stage F3, the seventh transistor T7 is turned off under the control of the high level of the first light-emitting control signal em1, the eighth transistor T8 is turned off under the control of the high level of the second light-emitting control signal em2, the tenth transistor T10 is turned off under the control of the high level of the fourth control signal cs4, the fourth transistor T4 is turned on under the control of the low level of the second control signal cs2, and the third transistor T3, the sixth transistor T6, the fifth transistor T5, and the ninth transistor T9 are turned off under the control of the high level of the first control signal cs1. The turned-on fourth transistor T4 inputs the data voltage Vda from the data signal terminal DA to the first node N1. Then the voltage VN2 changes from (Vth+Vref1) to:

$$( Vth + Vref 1 ) + \frac{{C}_{2}}{( {C}_{2} + Cgs\_T10 + Cgs\_T9 + Cgs\_T0 + Cgs\_T1 + Cgs\_T2 )} * ( Vda - Vref 2 )$$

Moreover, the leakage current of the gate of the drive transistor T0 is reduced due to the effect of the signal from the leakage adjustment signal terminal VS, which may further maintain the stability of the voltage of the gate of the drive transistor T0.

In the fourth stage F4, the seventh transistor T7 is turned on under the control of the low level of the first light-emitting control signal em1, the eighth transistor T8 is turned off under the control of the high level of the second light-emitting control signal em2, the tenth transistor T10 is turned off under the control of the high level of the fourth control signal cs4, the fourth transistor T4 is turned off under the control of the high level of the second control signal cs2, and the third transistor T3, the sixth transistor T6, the fifth transistor T5, and the ninth transistor T9 are turned off under the control of the high level of the first control signal cs1. The turned-on seventh transistor T7 provides the signal from the first power supply terminal VDD to the first electrode of the drive transistor T0. Moreover, the leakage current of the gate of the drive transistor T0 is reduced due to the effect of the signal of the leakage adjustment signal terminal VS, which may further maintain the stability of the voltage of the gate of the drive transistor T0.

In the fifth stage F5, the seventh transistor T7 is turned on under the control of the low level of the first light-emitting control signal em1, the eighth transistor T8 is turned on under the control of the low level of the second light-emitting control signal em2, the tenth transistor T10 is turned off under the control of the high level of the fourth control signal cs4, the fourth transistor T4 is turned off under the control of the high level of the second control signal cs2, and the third transistor T3, the sixth transistor T6, the fifth transistor T5, and the ninth transistor T9 are turned off under the control of the high level of the first control signal cs1. The turned-on seventh transistor T7 provides the signal of the first power supply terminal VDD to the first electrode of the drive transistor T0, so that the voltage at the first electrode of the drive transistor T0 is the first power supply voltage Vdd. The turned-on eighth transistor T8 bring the second electrode of the drive transistor T0 into conduction with the light-emitting device L. Thus, the drive transistor T0 generates a drive current Ids for driving the light-emitting device L to emit light, and controls the light-emitting device L to emit light. The drive transistor T0 generates the operating current Ids for driving the light-emitting device L to emit light, and Ids satisfies the following formula:

$$Ids = {k [ ( Vref 1 + \frac{{C}_{2}}{( {C}_{2} + {Cgs}_{T 10} + {Cgs}_{T 9} + {Cgs}_{T 0} + {Cgs}_{T 1} + {Cgs}_{T 2} )} * ( Vda - Vref ) - Vdd ]}^{2} .$$

Moreover, the leakage current of the gate of the drive transistor T0 is reduced due to the effect of the signal of the leakage adjustment signal terminal VS, which may further maintain the stability of the voltage of the gate of the drive transistor T0.

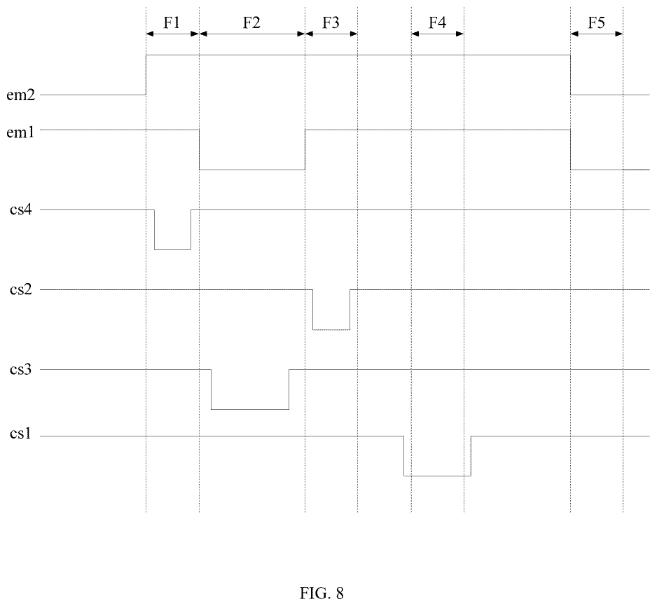

Embodiments of the present disclosure provide a timing chart of signals of yet some other pixel circuits, as shown in FIG. 8, which are morphed with respect to the implementations in the above-described embodiments. Only the differences between the present embodiments and the above embodiments are described below, and their general similarities will not be repeated herein.

Exemplarily, the timing chart of the signals corresponding to the pixel circuit shown in FIG. 3 may also be shown in FIG. 8. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, cs3 represents a third control signal from the third control signal terminal CS3, cs4 represents a fourth control signal from the fourth control signal terminal CS4. Exemplarily, if any two of the first control signal cs1, the second control signal cs2, the third control signal cs3, and the fourth control signal cs4 are not the same, the first control signal terminal CS1, the second control signal terminal CS2, the third control signal terminal CS3, and the fourth control signal terminal CS4 may be set as different signal terminals.

Exemplarily, as shown in FIG. 8, in one display frame, an effective level (e.g., low level) of the first light-emitting control signal em1 from the first light-emitting control signal terminal EM1 has an overlapping region with an effective level (e.g., low level) of the third control signal cs3 from the third control signal terminal CS3, and an effective level (e.g., low level) of the second control signal cs2 from the second control signal terminal CS2 occurs after the effective level (e.g., low level) of the third control signal cs3 from the third control signal terminal CS3, and the effective level (e.g., low level) of the first control signal cs1 from the first control signal terminal CS1 occurs after the effective level (e.g., low level) of the second control signal cs2 from the second control signal terminal CS2. This enables the compensation for the voltage at the first power supply terminal.

Exemplarily, if the effective level (e.g., low level) of the first light-emitting control signal em1 from the first light-emitting control signal terminal EM1 has an overlapping region with the effective level (e.g., low level) of the third control signal cs3 from the third control signal terminal CS3, the seventh transistor T7, the fifth transistor T5, and the ninth transistor T9 are all turned on during a time duration of this overlapping region.

Exemplarily, a gate drive circuit and a light-emitting control circuit may be provided in the non-display region of the base substrate to drive each transistor in the pixel circuit.

In some examples, combining FIG. 3 with FIG. 8, three gate drive circuits (each gate drive circuit may include a plurality of cascaded shift register units) and two light-emitting control circuits (each light-emitting control circuit may include a plurality of cascaded shift register units) may be provided in the non-display region. The first control signal cs1 from the first control signal terminal CS1 may be input using the 1^{st} gate drive circuit among the three gate drive circuits. The third control signal cs3 from the third control signal terminal CS3 may be input using the 2^{nd} gate drive circuit among the three gate drive circuits. The second control signal cs2 from the second control signal terminal CS2 and the fourth control signal cs4 from the fourth control signal terminal CS4 may be input using the 3^{rd} gate drive circuit among the three gate drive circuits. Additionally, the first light-emitting control signal em1 from the first light-emitting control signal terminal EM1 may be input using the 1^{st} light-emitting control circuit of the two light-emitting control circuits. The second light-emitting control signal em2 from the second light-emitting control signal terminal EM2 may input using the 2^{nd} light-emitting control circuit of the two light-emitting control circuits.

Exemplarily, for the first control signal cs1 to the fourth control signal cs4 received by the pixel circuits in the n^{th} row of sub-pixels, the first control signal cs1 may be a signal input by the n^{th} stage shift register unit in the 1^{st} gate drive circuit. The third control signal cs3 may be the signal input by the n^{th} stage shift register unit in the 2^{nd} gate drive circuit. As well, the fourth control signal cs4 may be a signal (e.g., Gate (n−3)) input by the (n−3)^{th} stage shift register unit in the 3^{rd} gate drive circuit, and the second control signal cs2 is a signal (e.g., Gate (n)) input by the n^{th} stage shift register unit in the 3^{rd} gate drive circuit. As well, the first light-emitting control signal em1 from the first light-emitting control signal terminal EM1 may be a signal input by the n^{th} stage shift register unit in the 1^{st} light-emitting control circuit. As well, the second light-emitting control signal em2 from the second light-emitting control signal terminal EM2 may be a signal input by the n^{th} stage shift register unit in the 2^{nd} light-emitting control circuit.

The following describes the operating process of the pixel circuit provided in the embodiments of the present disclosure within one display frame, taking the structure of the pixel circuit shown in FIG. 3 as an example, in conjunction with a timing chart of signals shown in FIG. 8. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, cs3 represents a third control signal from the third control signal terminal CS3, and cs4 represents a fourth control signal from the fourth control signal terminal CS4.

In the first stage F1, the seventh transistor T7 is turned off under the control of the high level of the first light-emitting control signal em1, the eighth transistor T8 is turned off under the control of the high level of the second light-emitting control signal em2, the third transistor T3 and the sixth transistor T6 are turned off under the control of the high level of the first control signal cs1, the tenth transistor T10 is turned on under the control of the low level of the fourth control signal cs4, the fourth transistor T4 is turned off under the control of the high level of the second control signal cs2, and the fifth transistor T5 and the ninth transistor T9 are turned off under the control of the high level of the third control signal cs3. The turned-on tenth transistor T10 provides the signal from the second initialization signal terminal VINIT2 to the gate of the drive transistor T0 to reset the gate of the drive transistor T0. Then, VN2=Vinit2.

In the second stage F2, the seventh transistor T7 is turned on under the control of the low level of the first light-emitting control signal em1, the eighth transistor T8 is turned off under the control of the high level of the second light-emitting control signal em2, the third transistor T3 and the sixth transistor T6 are turned off under the control of the high level of the first control signal cs1, the tenth transistor T10 is turned off under the control of the high level of the fourth control signal cs4, the fourth transistor T4 is turned off under the control of the high level of the second control signal cs2, and the fifth transistor T5 and the ninth transistor T9 are turned on under the control of the low level of the third control signal cs3. The turned-on seventh transistor T7 provides the signal from the first power supply terminal VDD to the first electrode of the drive transistor T0. The turned-on fifth transistor T5 provides the signal of the second reference voltage signal terminal VREF2 to the first node N1. Then, VN1=Vref2. the turned-on ninth transistor T9 brings the gate of the drive transistor T0 into conduction with the second electrode of the drive transistor T0, then VN2=Vth+Vdd.

In the third stage F3, the seventh transistor T7 is turned off under the control of the high level of the first light-emitting control signal em1, the eighth transistor T8 is turned off under the control of the high level of the second light-emitting control signal em2, the third transistor T3 and the sixth transistor T6 are turned off under the control of the high level of the first control signal cs1, the tenth transistor T10 is turned off under the control of the high level of the fourth control signal cs4, the fourth transistor T4 is turned on under the control of the low level of the second control signal cs2, and the fifth transistor T5 and the ninth transistor T9 are turned off under the control of the high level of the third control signal cs3. The turned-on fourth transistor T4 inputs the data voltage Vda from the data signal terminal DA to the first node N1, then the voltage VN1 changes from Vref1 to Vda, and the voltage VN2 changes with VN1, and voltage VN1 changes from (Vdd+Vth) to

$$( Vth + Vdd ) + \frac{{C}_{2}}{( {C}_{2} + Cgs\_T10 + Cgs\_T9 + Cgs\_T0 + Cgs\_T1 + Cgs\_T2 )} * ( Vda - Vref 2 ) .$$

Moreover, the leakage current of the gate of the drive transistor T0 is reduced due to the effect of the signal from the leakage adjustment signal terminal VS, which may further maintain the stability of the voltage of the gate of the drive transistor T0.

In the fourth stage F4, the seventh transistor T7 is turned off under the control of the high level of the first light-emitting control signal em1, the eighth transistor T8 is turned off under the control of the high level of the second light-emitting control signal em2, the third transistor T3 and the sixth transistor T6 are turned on under the control of the low level of the first control signal cs1, the tenth transistor T10 is turned off under the control of the high level of the fourth control signal cs4, the fourth transistor T4 is turned on under the control of the low level of the second control signal cs2, and the fifth transistor T5 and the ninth transistor T9 are turned off under the control of the high level of the third control signal cs3. The turned-on third transistor T3 provides a signal from the first reference voltage signal terminal VREF1 to the first electrode of the drive transistor T0 to reset the first electrode of the drive transistor T0. The turned-on sixth transistor T6 provides the signal of the first initialization signal terminal VINIT1 to the light-emitting device L to reset the light-emitting device L.

In the fifth stage F5, the seventh transistor T7 is turned on under the control of the low level of the first light-emitting control signal em1, the eighth transistor T8 is turned on under the control of the low level of the second light-emitting control signal em2, the third transistor T3 and the sixth transistor T6 are turned off under the control of the high level of the first control signal cs1, the tenth transistor T10 are turned off under the control of the high level of the fourth control signal cs4, the fourth transistor T4 is turned off under the control of the high level of the second control signal cs2, and the fifth transistor T5 and the ninth transistor T9 are turned off under the control of the high level of the third control signal cs3. The turned-on seventh transistor T7 provides the signal of the first power supply terminal VDD to the first electrode of the drive transistor T0, so that the voltage at the first electrode of the drive transistor T0 is the first power supply voltage Vdd. The turned-on eighth transistor T8 brings the second electrode of the drive transistor T0 into conduction with the light-emitting device L. The drive transistor T0 is caused to generate a drive current Ids for driving the light-emitting device L to emit light, and controls the light-emitting device L to emit light. The drive transistor T0 generates the operating current of Ids for driving the light-emitting device L to emit light, and Ids satisfies the following formula:

$${[ Ids = k \frac{{C}_{2}}{( {C}_{2} + {Cgs}_{T 10} + {Cgs}_{T 9} + {Cgs}_{T 0} + {Cgs}_{T 1} + {Cgs}_{T 2} )} * ( Vda - Vref 2 ) ]}^{2} .$$

Moreover, the leakage current of the gate of the drive transistor T0 is reduced due to the effect of the signal from the leakage adjustment signal terminal VS, which may further maintain the stability of the voltage of the gate of the drive transistor T0. As well, the compensation for the voltage at the first power supply terminal can thus be realized.

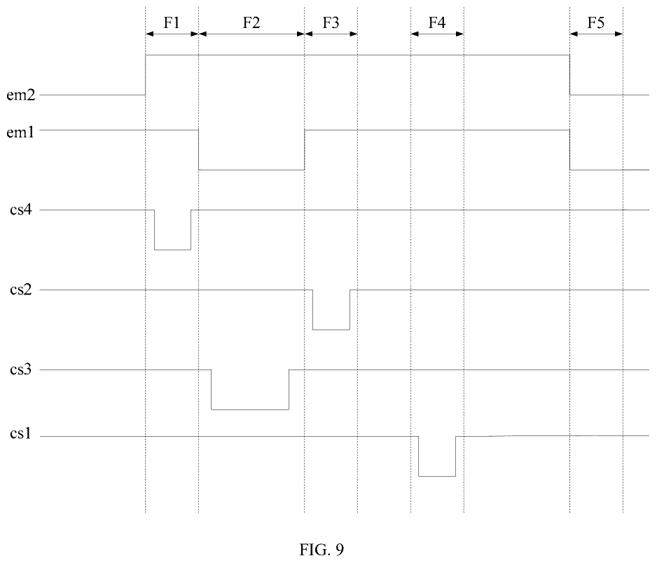

Embodiments of the present disclosure provide a timing chart of signals of yet some other pixel circuits, as shown in FIG. 9, which are morphed with respect to the implementations in the above-described embodiments. Only the differences between the present embodiments and the above embodiments are described below, and their general similarities will not be repeated herein.

Exemplarily, a timing chart of signals corresponding to the pixel circuit shown in FIG. 3 may also be shown in FIG. 9. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, cs3 represents a third control signal from the third control signal terminal CS3, cs4 represents a fourth control signal from the fourth control signal terminal CS4. Exemplarily, if any two of the first control signal cs1, the second control signal cs2, the third control signal cs3, and the fourth control signal cs4 are not the same, the first control signal terminal CS1, the second control signal terminal CS2, the third control signal terminal CS3, and the fourth control signal terminal CS4 may be set as different signal terminals.

Exemplarily, as shown in FIG. 9, in one display frame, an effective level (e.g., low level) of the first light-emitting control signal em1 from the first light-emitting control signal terminal EM1 has an overlapping region with an effective level (e.g., low level) of the third control signal cs3 from the third control signal terminal CS3, and an effective level (e.g., low level) of the second control signal cs2 from the second control signal terminal CS2 occurs after the effective level (e.g., low level) of the third control signal cs3 from the third control signal terminal CS3, and the effective level (e.g., low level) of the first control signal cs1 from the first control signal terminal CS1 occurs after the effective level (e.g., low level) of the second control signal cs2 from the second control signal terminal CS2. This enables the compensation for the voltage at the first power supply terminal.

Exemplarily, if the effective level (e.g., low level) of the first light-emitting control signal em1 from the first light-emitting control signal terminal EM1 has an overlapping region with the effective level (e.g., low level) of the third control signal cs3 from the third control signal terminal CS3, the seventh transistor T7, the fifth transistor T5, and the ninth transistor T9 are all turned on in the time duration of this overlapping region.

In some examples, combining FIG. 3 with FIG. 9, two gate drive circuits (each gate drive circuit may include a plurality of cascaded shift register units) and two light-emitting control circuits (each light-emitting control circuit may include a plurality of cascaded shift register units) may be arranged in the non-display region. This saves the quantity of gate drive circuits and reduces the occupied space. The third control signal cs3 from the third control signal terminal CS3 may be input using the 1^{st} gate drive circuit of the two gate drive circuits. The first control signal cs1 from the first control signal terminal CS1, the second control signal cs2 from the second control signal terminal CS2, and the fourth control signal cs4 from the fourth control signal terminal CS4 may be input using the 2^{nd} gate drive circuit of the two gate drive circuits. Additionally, the first light-emitting control signal em1 from the first light-emitting control signal terminal EM1 may be input using the 1^{st} light-emitting control circuit of the two light-emitting control circuits. The second light-emitting control signal em2 from the second light-emitting control signal terminal EM2 may input using the 2^{nd} light-emitting control circuit of the two light-emitting control circuits.

Exemplarily, for the first control signal cs1 to the fourth control signal cs4 received by the pixel circuits in the n^{th} row of sub-pixels, the third control signal cs3 may be the signal input by the n^{th} stage shift register unit in the 1^{st} gate drive circuit. As well, the fourth control signal cs4 may be the signal (e.g., Gate (n−3)) input by the (n−3)^{th} stage shift register unit in the 2^{nd} gate drive circuit, and the second control signal cs2 is the signal (e.g., Gate (n)) input by the n^{th} stage shift register unit in the 2^{nd} gate drive circuit, and the first control signal cs1 is the signal (e.g., Gate (n+2)) input by the (n+2)^{th} stage shift register unit in the 2^{nd} gate drive circuit. As well, the first light-emitting control signal em1 from the first light-emitting control signal terminal EM1 may be a signal input by the n^{th} stage shift register unit in the 1^{st} light-emitting control circuit. As well, the second light-emitting control signal em2 from the second light-emitting control signal terminal EM2 may be a signal input by the n^{th} stage shift register unit in the 2^{nd} light-emitting control circuit.

Moreover, the operating process of the pixel circuit shown in FIG. 3 in conjunction with a timing chart of signals shown in FIG. 9 may be described with reference to the above description and will not be repeated herein.

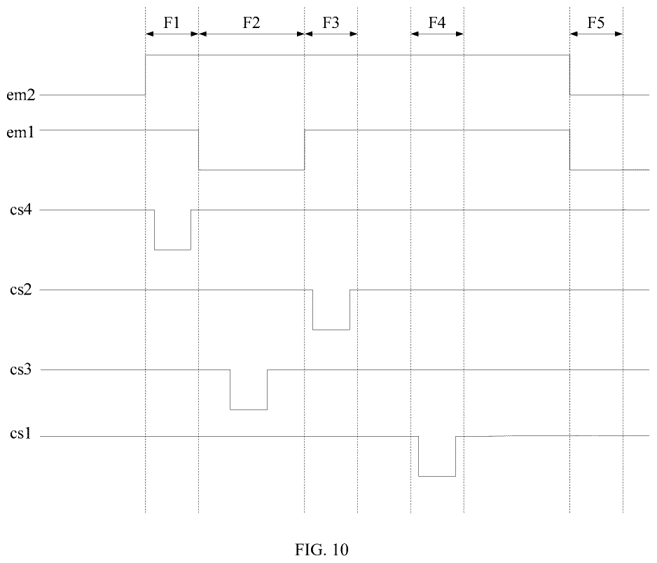

Embodiments of the present disclosure provide a timing chart of signals of yet some other pixel circuits, as shown in FIG. 10, which are morphed with respect to the implementations in the above-described embodiments. Only the differences between the present embodiments and the above embodiments are described below, and their general similarities will not be repeated herein.

Exemplarily, a timing chart of signals corresponding to the pixel circuit shown in FIG. 3 may also be shown in FIG. 10. Here, em1 represents a first light-emitting control signal from the first light-emitting control signal terminal EM1, em2 represents a second light-emitting control signal from the second light-emitting control signal terminal EM2, cs1 represents a first control signal from the first control signal terminal CS1, cs2 represents a second control signal from the second control signal terminal CS2, cs3 represents a third control signal from the third control signal terminal CS3, cs4 represents a fourth control signal from the fourth control signal terminal CS4. Exemplarily, if any two of the first control signal cs1, the second control signal cs2, the third control signal cs3, and the fourth control signal cs4 are not the same, the first control signal terminal CS1, the second control signal terminal CS2, the third control signal terminal CS3, and the fourth control signal terminal CS4 may be set as different signal terminals.

Exemplarily, as shown in FIG. 10, in one display frame, an effective level (e.g., low level) of the first light-emitting control signal em1 from the first light-emitting control signal terminal EM1 has an overlapping region with an effective level (e.g., low level) of the third control signal cs3 from the third control signal terminal CS3, and an effective level (e.g., low level) of the second control signal cs2 from the second control signal terminal CS2 occurs after the effective level (e.g., low level) of the third control signal cs3 from the third control signal terminal CS3, and the effective level (e.g., low level) of the first control signal cs1 from the first control signal terminal CS1 occurs after the effective level (e.g., low level) of the second control signal cs2 from the second control signal terminal CS2. This enables the compensation for the voltage at the first power supply terminal.

Exemplarily, if the effective level (e.g., low level) of the first light-emitting control signal em1 from the first light-emitting control signal terminal EM1 has an overlapping region with the effective level (e.g., low level) of the third control signal cs3 from the third control signal terminal CS3, the seventh transistor T7, the fifth transistor T5, and the ninth transistor T9 are all turned on in the time duration of this overlapping region.

In some examples, combining FIG. 3 with FIG. 10, one gate drive circuit (the gate drive circuit may include a plurality of cascaded shift register units) and two light-emitting control circuits (each of light-emitting control circuits may include a plurality of cascaded shift register units) may be arranged in the non-display region. This saves the quantity of gate drive circuits and reduces the occupied space. Here, the first control signal cs1 from the first control signal terminal CS1, the second control signal cs2 from the second control signal terminal CS2, the third control signal cs3 from the third control signal terminal CS3, and the fourth control signal cs4 from the fourth control signal terminal CS4 may be input busing this gate drive circuit. Moreover, the first light-emitting control signal em1 from the first light-emitting control signal terminal EM1 may be input using the 1^{st} light-emitting control circuit of the two light-emitting control circuits. The second light-emitting control signal em2 from the second light-emitting control signal terminal EM2 may be input using the 2^{nd} light-emitting control circuit of the two light-emitting control circuits.

Exemplarily, for the first control signal cs1 to the fourth control signal cs4 received by the pixel circuits in the n^{th} row of sub-pixels, the fourth control signal cs4 may be the signal (e.g., Gate (n−3)) input by the (n−3)^{th} stage shift register unit in this gate drive circuit, the third control signal cs3 may be the signal (e.g., Gate (n−2)) input by the (n−2)^{th} stage shift register unit in this gate drive circuit, and the second control signal cs2 is the signal (e.g., Gate (n)) input by the n^{th} stage shift register unit in this gate drive circuit and the first control signal cs1 is the signal (e.g., Gate (n+2)) input by the (n+2)^{th} stage shift register unit in this gate drive circuit. As well, the first light-emitting control signal em1 from the first light-emitting control signal terminal EM1 may be a signal input by the n^{th} stage shift register unit in the 1^{st} light-emitting control circuit. As well, the second light-emitting control signal em2 from the second light-emitting control signal terminal EM2 may be a signal input by the n^{th} stage shift register unit in the 2^{nd} light-emitting control circuit.

Moreover, the operating process of the pixel circuit shown in FIG. 3 in conjunction with a timing chart of signals shown in FIG. 10 may be described with reference to the above description and will not be repeated herein.

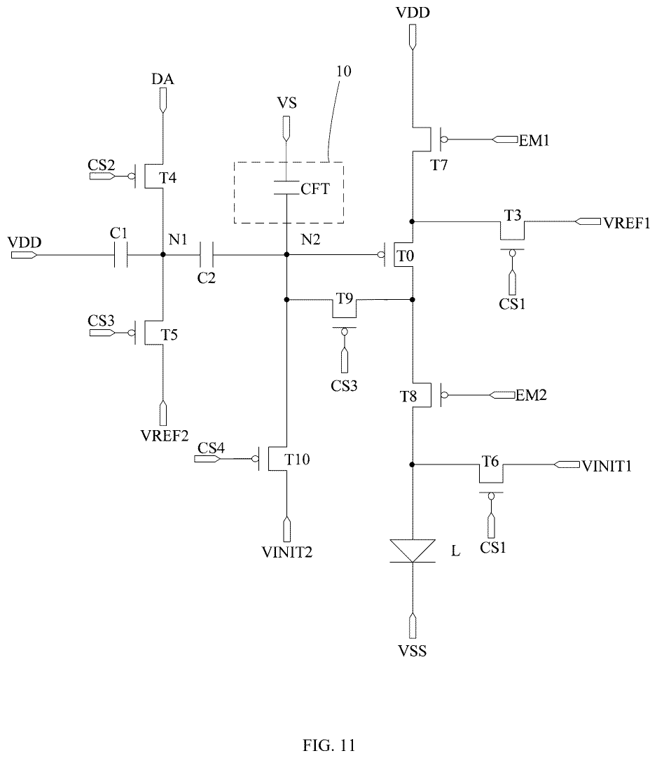

Embodiments of the present disclosure provide yet some other pixel circuits, as shown in FIG. 11, which are morphed with respect to the implementations in the above-described embodiments. Only the differences between the present embodiments and the above embodiments are described below, and their general similarities will not be repeated herein.

In some embodiments of the present disclosure, as shown in FIG. 11, the first control circuit 10 may also include: a voltage stabilizing capacitor CFT, here a first electrode of the voltage stabilizing capacitor CFT is coupled to the gate of the drive transistor T0, and a second electrode of the voltage stabilizing capacitor CFT is coupled to the leakage adjustment signal terminal VS. Thus, by means of the voltage stabilizing capacitor CFT, the leakage current of the gate of the drive transistor T0 can be reduced based on the signal from the leakage adjustment signal terminal VS, thereby mitigating the problem of the flicker in the low gray-scale display.

Exemplarily, the implementation of the signal from the leakage adjustment signal terminal VS can be set with reference to the above description and will not be repeated herein.

A timing chart of signals corresponding to the pixel circuit shown in FIG. 11 may be as shown in FIG. 4A or FIGS. 7 to 10. Moreover, the driving process of the pixel circuit provided by the embodiments of the present disclosure may be set up with reference to the above description and is not described herein.

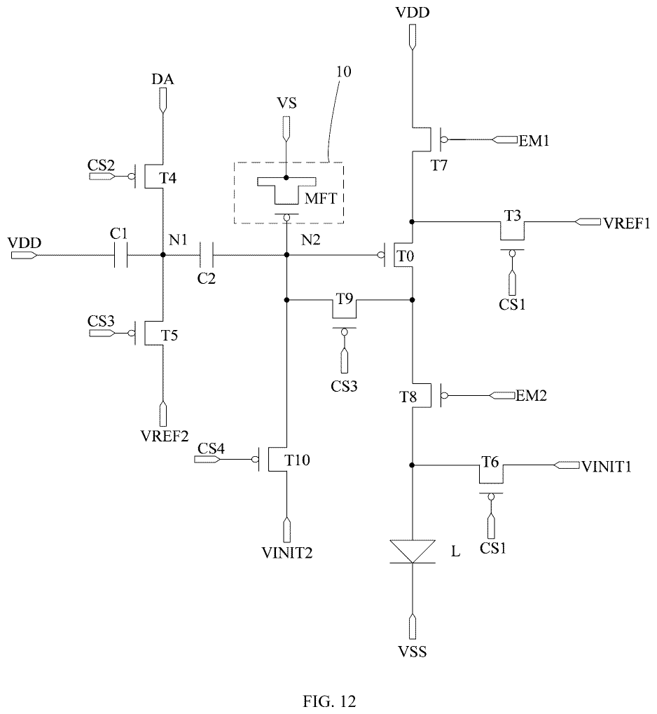

Embodiments of the present disclosure provide yet some other pixel circuits, as shown in FIG. 12, which are morphed with respect to the implementations in the above-described embodiments. Only the differences between the present embodiments and the above embodiments are described below, and their general similarities will not be repeated herein.

In some embodiments of the present disclosure, as shown in FIG. 12, the first control circuit 10 may also include: a compensation transistor MFT, in which a first electrode and a second electrode of the compensation transistor MFT are coupled to the leakage adjustment signal terminal VS, and a gate of the compensation transistor MFT is coupled to the gate of the drive transistor T0. In this manner, by providing a single transistor, the leakage current of the gate of the drive transistor T0 can be reduced based on the signal from the leakage adjustment signal terminal VS, thereby mitigating the problem of the flicker in the low gray-scale display.

Exemplarily, the gate of the compensation transistor may also be coupled to the leakage adjustment signal terminal, and the first electrode and the second electrode of the compensation transistor are coupled to the gate of the drive transistor, which are not limited herein.

Exemplarily, the implementation of the signal from the leakage adjustment signal terminal VS may be set with reference to the above description, and is not described herein.

A timing chart of signals corresponding to the pixel circuit shown in FIG. 12 may be as shown in FIG. 4A or FIGS. 7 to 10. Moreover, the driving process of the pixel circuit provided by the embodiments of the present disclosure may be described with reference to the above description and will not be repeated herein.

The embodiments of the present disclosure also provide a display apparatus including the above-described pixel circuit provided by the embodiments of the present disclosure. The display apparatus solves the problem in a similar principle as the aforementioned pixel circuit, so the implementation of the display apparatus can be referred to the implementation of the aforementioned pixel circuit, and the repetition will not be repeated herein.

It is to be noted that in specific implementation, in the embodiments of the present disclosure, the display apparatus may be: a mobile phone, a tablet computer, a television, a monitor, a laptop computer, a digital photo frame, a navigator, and any other product or component having a display function. Other essential components of the display apparatus should be understood by those of ordinary skill in the art, and are not described herein, nor should they be taken as limitations on the present disclosure.

Although preferred embodiments of the present disclosure have been described, additional changes and modifications may be made to these embodiments once the basic inventive concepts are known to one of skill in the art. Therefore, the appended claims are intended to be construed to include the preferred embodiments as well as all changes and modifications that fall within the scope of the present disclosure.

Obviously, a person skilled in the art can make various modifications and variations to the presently disclosed embodiments without departing from the spirit and scope of the presently disclosed embodiments. Thus, if such modifications and variations of the presently disclosed embodiments fall within the scope of the presently disclosed claims and their technical equivalents, the present disclosure is intended to include such modifications and variations.

1. A pixel circuit comprising:
a light-emitting device;
a drive transistor, coupled to the light-emitting device and configured to, based on a data voltage, generate an operating current to drive the light-emitting device;
a first control circuit, coupled to a gate of the drive transistor and configured to, based on a signal from a leakage adjustment signal terminal, reduce a leakage current of the gate of the drive transistor;
a second control circuit, coupled to the drive transistor and the light-emitting device, and configured to reset the drive transistor and the light-emitting device, control the data voltage to be input into the gate of the drive transistor, and control the drive transistor to generate the operating current to drive the light-emitting device to emit light.

2. The pixel circuit according to claim 1, wherein the second control circuit comprises: a first control sub-circuit; wherein
the first control sub-circuit is configured to provide a signal from a first initialization signal terminal to the light-emitting device in response to a signal from a first control signal terminal, bring a first power supply terminal into conduction with a first electrode of the drive transistor in response to a signal from a first light-emitting control signal terminal, bring a second electrode of the drive transistor into conduction with the light-emitting device in response to a signal from a second light-emitting control signal terminal, bring the gate of the drive transistor into conduction with the second electrode of the drive transistor in response to a signal from a third control signal terminal, and provide a signal from a second initialization signal terminal to the gate of the drive transistor in response to a signal from a fourth control signal terminal.

3. The pixel circuit according to claim 2, wherein the second control circuit further comprises:
a second control sub-circuit, configured to provide a data voltage at a data signal terminal to a first node in response to a signal from a second control signal terminal, and provide a signal from a second reference voltage signal terminal to the first node in response to the signal from the third control signal terminal.

4. The pixel circuit according to claim 2, wherein the second control circuit further comprises: a third control sub-circuit; wherein
the third control sub-circuit is configured to provide a signal from a first reference voltage signal terminal to the first electrode of the drive transistor in response to the signal from the first control signal terminal.

5. The pixel circuit according to claim 3, wherein, in one display frame, an effective level of the first control signal terminal occurs before an effective level of the second control signal terminal, wherein the effective level of the first control signal terminal has an overlapping region with an effective level of the third control signal terminal.

6. The pixel circuit according to claim 3, wherein the first control signal terminal and the third control signal terminal receive a same one signal; and
in one display frame, an effective level of the first control signal terminal occurs before an effective level of the second control signal terminal.

7. The pixel circuit according to claim 3, wherein, in one display frame, an effective level of the first light-emitting control signal terminal has an overlapping region with an effective level of the third control signal terminal, an effective level of the second control signal terminal occurs after the effective level of the third control signal terminal, and an effective level of the first control signal terminal occurs after the effective level of the second control signal terminal.

8. The pixel circuit according to claim 1, wherein the first control circuit comprises: a first transistor and a second transistor; wherein
a gate of the first transistor is coupled to the leakage adjustment signal terminal, a first electrode of the first transistor floats, and a second electrode of the first transistor is coupled to the gate of the drive transistor; and
a gate of the second transistor is coupled to the leakage adjustment signal terminal, a first electrode of the second transistor floats, and a second electrode of the second transistor is coupled to the gate of the drive transistor.

9. The pixel circuit according to claim 1, wherein the first control circuit comprises: a voltage stabilizing capacitor; wherein
a first electrode of the voltage stabilizing capacitor is coupled to the gate of the drive transistor, and a second electrode of the voltage stabilizing capacitor is coupled to the leakage adjustment signal terminal.

10. The pixel circuit according to claim 1, wherein the first control circuit comprises: a compensation transistor; wherein
a first electrode and a second electrode of the compensation transistor are coupled to the leakage adjustment signal terminal, and a gate of the compensation transistor is coupled to the gate of the drive transistor;
or, a gate of the compensation transistor is coupled to the leakage adjustment signal terminal, and a first electrode and a second electrode of the compensation transistor are coupled to the gate of the drive transistor.

11. The pixel circuit according to claim 1, wherein, in one display frame, a voltage of the signal from the leakage adjustment signal terminal is a first voltage when resetting the gate of the drive transistor, and a voltage of the signal from the leakage adjustment signal terminal is a second voltage when inputting the data voltage into the gate of the drive transistor; and
the second voltage is not less than the first voltage.

12. The pixel circuit according to claim 11, wherein first voltages in different display frames are the same; and
in each of different display frames, the second voltage is greater than a third voltage; wherein the third voltage is (Vda−Vth), wherein Vda represents the data voltage, and Vth represents a threshold voltage of the drive transistor.

13. The pixel circuit according to claim 12, wherein second voltages in different display frames are the same;
or, second voltages in different display frames increase with an increase of third voltages in different display frames.

14. The pixel circuit according to claim 4, wherein the third control sub-circuit comprises: a third transistor; wherein
a gate of the third transistor is coupled to the first control signal terminal, a first electrode of the third transistor is coupled to the first electrode of the drive transistor, and a second electrode of the third transistor is coupled to the first reference voltage signal terminal.

15. The pixel circuit according to claim 3, wherein the second control sub-circuit comprises: a fourth transistor, a fifth transistor, and a first capacitor; wherein
a gate of the fourth transistor is coupled to the second control signal terminal, a first electrode of the fourth transistor is coupled to the data signal terminal, and a second electrode of the fourth transistor is coupled to the first node;
a gate of the fifth transistor is coupled to the third control signal terminal, a first electrode of the fifth transistor is coupled to the first node, and a second electrode of the fifth transistor is coupled to the second reference voltage signal terminal; and
a first electrode of the first capacitor is coupled to the first power supply terminal, and a second electrode of the first capacitor is coupled to the first node.

16. The pixel circuit according to claim 2, wherein the first control sub-circuit comprises: a sixth transistor, a seventh transistor, an eighth transistor, a ninth transistor, a tenth transistor, and a second capacitor; wherein
a gate of the sixth transistor is coupled to the first control signal terminal, a first electrode of the sixth transistor is coupled to the light-emitting device, and a second electrode of the sixth transistor is coupled to the first initialization signal terminal;
a gate of the seventh transistor is coupled to the first light-emitting control signal terminal, a first electrode of the seventh transistor is coupled to the first power supply terminal, and a second electrode of the seventh transistor is coupled to the first electrode of the drive transistor;
a gate of the eighth transistor is coupled to the second light-emitting control signal terminal, a first electrode of the eighth transistor is coupled to the second electrode of the drive transistor, and a second electrode of the eighth transistor is coupled to the light-emitting device;
a gate of the ninth transistor is coupled to the third control signal terminal, a first electrode of the ninth transistor is coupled to the gate of the drive transistor, and a second electrode of the ninth transistor is coupled to the second electrode of the drive transistor;
a gate of the tenth transistor is coupled to the fourth control signal terminal, a first electrode of the tenth transistor is coupled to the gate of the drive transistor, and a second electrode of the tenth transistor is coupled to the second initialization signal terminal; and
a first electrode of the second capacitor is coupled to the first node, and a second electrode of the second capacitor is coupled to the gate of the drive transistor.

17. A display apparatus, comprising: the pixel circuit according to claim 1.

18. A driving method of the pixel circuit according to claim 1, comprising:
in a data writing stage: reducing, by the first control circuit, the leakage current of the gate of the drive transistor based on the signal from the leakage adjustment signal terminal; and controlling, by the second control circuit, the data voltage to be input into the gate of the drive transistor; and
in a light-emitting stage: reducing, by the first control circuit, the leakage current of the gate of the drive transistor based on the signal from the leakage adjustment signal terminal; and controlling, by the second control circuit, the drive transistor to generate the operating current to drive the light-emitting device to emit light.

19. The pixel circuit according to claim 3, wherein the second control circuit further comprises: a third control sub-circuit; wherein
the third control sub-circuit is configured to provide a signal from a first reference voltage signal terminal to the first electrode of the drive transistor in response to the signal from the first control signal terminal.
